(19) United States
(12) Patent Application Publication
(10) Pub. No.: US 2008/0226378 A1
(43) Pub. Date: Sep. 18, 2008

(54) MULTI-FUNCTION COMBINATION PEN

(76) Inventor: Rong-Lin Sheu, Wu Jieh Hsiang (TW)

Correspondence Address: LEONG C LEI, PMB # 1008, 1867 YGNACIO VALLEY ROAD, WALNUT CREEK, CA, 94598, US

(21) Appl. No.: 11/686,358

(22) Filed: Mar. 15, 2007

(51) Int. Cl. B43K 27/02

(52) U.S. Cl. 401/18

(57) ABSTRACT

A combination pen includes a tubular barrel having two open ends for selectively receiving different stationery devices so that different stationery devices can be combined together with the barrel. The stationery devices received in the barrel can be replaced if desire so that any combination that is desired by a user or that is of practical use can be made with respect to different kinds of stationery devices. The stationary devices can be selectively combined together for saving of space and ease of stowage.

### BACKGROUND OF THE INVENTION

(a) Technical Field of the Invention

The present invention relates to a multi-function combination pen, which provides a mechanical pencil, a ball pen, leads, eraser, correction liquid with a tubular or bar-like stationery devices with reduced length as compared to a regular pen, to be selectively and releasably fit in a tubular barrel having opposite open ends through which different ones of the stationery devices can be inserted into and held by the barrel in an arbitrary removal manner so that a user is allowed to carry any desired combination of the stationery devices with the barrel according to his or her needs so that an easy-to-operate and practical device is provided without changing the original functions of the stationery devices and further provided with a variety of different combinations of the stationery devices.

(b) Description of the Prior Art

A conventional writing implement is of a suitable length, such as around 15 cm, for ease of writing. For a regular pencil, it is always a problem for pencils that are gradually reduced in length and once the pencils are reduced to around one half of the original length, they become difficult for users to write. Thus, most of these length-reduced pencils are simply disposed of by the users. A mechanical pencil is operated by manual depression, which advances a lead contained in the mechanism pencil to a desired position for writing. All the writing implements, including the ball pen and the pencil, are provided for writing. However, in case there is a need for using two or more writing implements at substantially the same time, for example leads of different codes, such as H, HB, 2B, or ball pens of different colors, such a red, blue, and black, the user must carry all the pens that are needed. Besides pens, erasers and correction liquid are often required by a user and must be carried together with the pens. This often cases problems to the users for these articles are small in size, making they very easy to be accidentally left at an un-recalled position.

The present invention is aimed to overcome the above discussed problems.

### SUMMARY OF THE INVENTION

The primary purpose of the present invention is to The primary objective of the present invention is to provide a combination pen that is easy for disassembling and interchanging and can be arbitrarily modified. The combination pen comprises a tubular barrel and stationery devices, such as a pencil, a ball pen, an eraser, and a correction liquid, are made in a tubular or bar-like form with an outside diameter smaller than the inside diameter of the barrel so that the stationery device can be fit into the barrel though end openings thereof. This allows a user to disassembling and changing any of the stationery devices as desired and a desired combination tool can be formed by arbitrary combinations of the stationery devices according to practical needs for use of the combination pen. The present invention can be easily and efficiently assembling/disassembling and is convenient for carrying and occupying a very limited space. The stationery devices can be combined together by a barrel of the present invention to provide not only convenient and efficient use but also a variety of combinations that can serve as entertainment sources.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating principles of the present invention is shown by way of illustrative example.

### BRIEF DESCRIPTION OF THE DRAWINGS

FIG. 1 is a perspective view of a combination barrel constructed in accordance with the present invention;

FIG. 2 is a cross-sectional view of the barrel of the present invention;

FIG. 3 is a side elevational view of a writing implement to be combined with the barrel in accordance with the present invention;

FIG. 4 is a side elevational view of a lead container to be combined with the barrel in accordance with the present invention;

FIG. 5 is a side elevational view of a eraser holder to be combined with the barrel in accordance with the present invention;

FIG. 6 is a side elevational view of a correction liquid container to be combined with the barrel in accordance with the present invention;

FIG. 7 is a cross-sectional view illustrating the writing implement received in the barrel in accordance with the present invention;

FIG. 8 is similar to FIG. 7 but showing the writing implement 2 in a stowed condition;

FIG. 9 is a cross-sectional view illustrating the writing implement and the lead container received in the barrel in accordance with the present invention;

FIG. 10 is a cross-sectional view illustrating the writing implement and the eraser holder received in the barrel in accordance with the present invention; and

FIG. 11 is a cross-sectional view illustrating the writing implement and the correction liquid container received in the barrel in accordance with the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

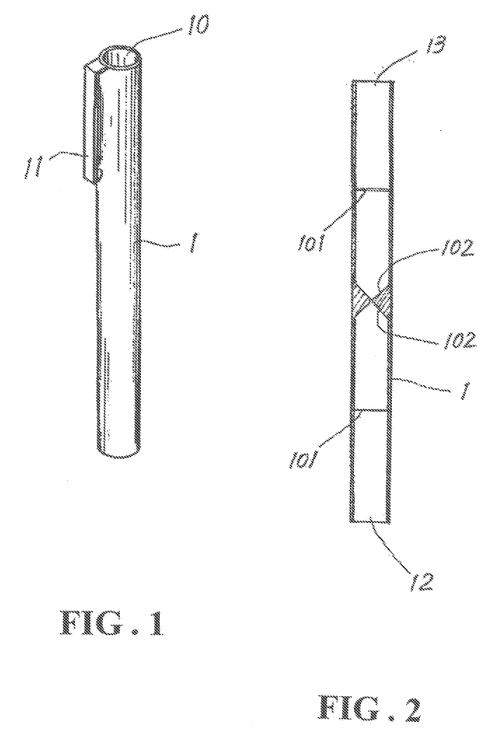

With reference to the drawings and in particular to FIG. 1, a combination pen constructed in accordance with the present invention comprises an elongated barrel 1 through which an axial bore 10 of a predetermined inside diameter is defined to thereby making the barrel 1 a hollow tubular member. The barrel 1 has a length that substantially corresponds to that of a regular pen. A clip 11 is formed at and mounted to an end of the barrel 1 for selectively securing the combination pen of the present invention to for example a pocket. Also referring to FIG. 2, which shows the inside structure of the barrel 1 in a cross-sectional form. The barrel 1 has an inside surface on which two circumferential snapping grooves 101 are formed at upper and lower sections of the barrel 1, respectively. An internal projection is formed at a middle of the inside surface of the barrel 1 and forms at least one inclined face 102 corresponding to the upper or lower section or two opposite inclined faces 102 corresponding to the upper and lower sections respectively. Further, the bore 10 forms upper and lower openings 13, 12 at opposite axial ends of the barrel 1.

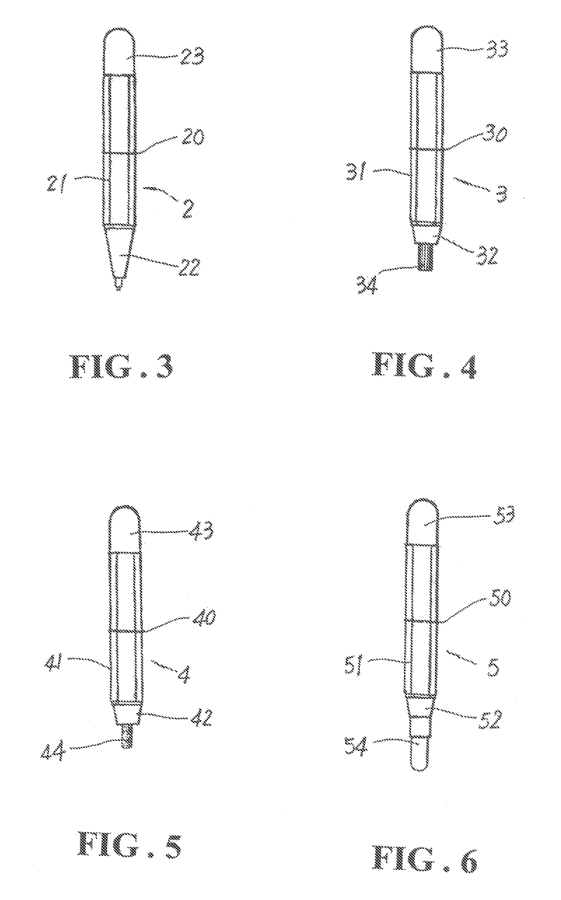

Also referring to FIG. 3, a writing implement in accordance with the present invention, generally designated with reference numeral 2, is illustrated for combination with the barrel 1. The writing implement 2 comprises a body 21 having opposite ends forming an end cap 23 and a conic end 22 respectively. The body 21 is axially elongated and has an outer diameter or cross-sectional dimension that is slightly smaller than the inside diameter of the bore 10 of the barrel 1 whereby the writing implement 2 is receivable in the barrel 1 through the upper or lower opening 13, 12. The body 21 has an outer surface around which a circumferential retention rib 20 is formed, having an outside diameter that is slightly larger than the inside diameter of the barrel 1 but is elastically deformable so that when the writing implement 2 is inserted in to the barrel 1, the retention rib 2 is slightly deformed to allow the writing implement 2 to slide inside the bore 10 of the barrel 1 and eventually reaching and engaging the snapping groove 101 to secure the body 21 of the writing implement 2 inside the upper or lower section of the barrel 1 thereby serving as a regular pen, which can be used by a user in an ordinary way to do writing. The writing implement 2 can be for example a ball pen, which can be made in any desired length, especially such a length that can be exactly fit in the upper or lower section of the barrel 1. However, in case that the writing implement 2 is a mechanical pencil, which is generally operated by pushed an end cap to advance a lead to a desired position and which would be troublesome for user to combine the regular mechanical pencil in the barrel 1 of the present invention. Apparently, a modified mechanical pencil of which the lead is advanced by a reaction from a piece on paper on which the mechanical pencil writes can be perfectly fit in the barrel 1 and such a modified mechanical pencil is described in a previous patent application of the present applicant.

FIGS. 4-6 show other applications of the combination pen of the present invention. FIG. 4 shows a lead container 3 that stores leads of mechanical pencils. The lead container 3 comprises a tubular body 31 having opposite ends forming an end cap 33 and a conic end 32 respectively. Also a stopper cap 34 is provided at the conic end 32 to selectively release leads (not shown) from the lead container 3. The body 31 is, again, axially elongated and has an outer diameter or cross-sectional dimension that is slightly smaller than the inside diameter of the bore 10 of the barrel 1 whereby the lead container 3 is receivable in the barrel 1 through the upper or lower opening 13, 12. The body 31 has an outer surface around which a circumferential retention rib 30 is formed. The body 31 is of the same geometry, including the length and the location of the retention rib, as the body 21 of the writing implement 2. Thus, the lead container 3 can be fit into the barrel 1 through for example the upper opening 13. The lead container 3 and the writing implement 2 can be received in the upper and lower sections of the barrel 1 respectively. Alternatively, the lead container 3 and the writing implement 2 can be interchanged with each other. FIG. 5 shows an eraser holder 4, which is of the same outer configuration or geometry as that of the writing implement 2 or the lead container 3 and comprises a tubular body 41 having opposite ends forming an end cap 43 and a conic end 42 respectively. A circumferential retention rib 40 is formed on the body 41. An eraser bar 44 is received and held in the holder body 41 and is advanced in a helical movement manner, which is effected by manual rotation of the end cap 43 that serves as a driving means of the eraser bar 44. In other words, the eraser bar 44 can be advanced out of or withdrawn into the body 41 by rotation of the end cap 43. If desired, the eraser 44 can be made thinner than regular eraser bar 44 for erasing a smaller area without undesired erasing of adjacent characters or texts. FIG. 6 shows a correction liquid container 5, which, again, comprises a hollow body 51 having opposite ends forming an end cap 53 and a conic end 52 and a circumferential retention rib 50 is provided at a middle of the outer surface of the body 51. A sealing cap 54 is removably mounted to the conic end 52, which serving as an exit for the correction liquid container in the container 5. In other words, to use the correction liquid, the sealing cap 54 is removed to expose the exit through which the correction liquid is allowed to flow out of the container 5.

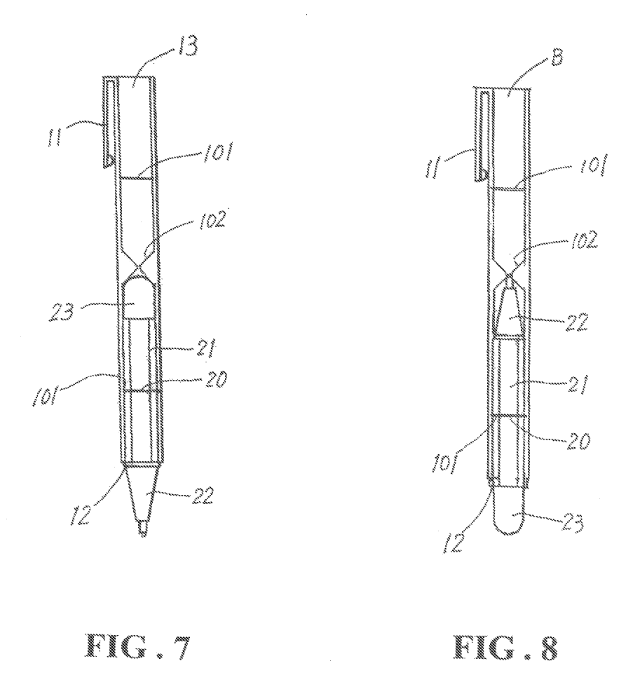

FIGS. 7 and 8 show combination of one of the devices, namely the writing implement 2, the lead container 3, the eraser holder 4, and the correction liquid container 5, and other devices of similar or different functions, with the barrel 1. In the embodiment illustrated in FIG. 1, the barrel 1 is provided with a clip 11 at an upper end thereof and thus, it is preferred to fit the writing implement 2 into the lower section of the barrel 1 through the lower opening 12. To use, the writing implement 2 is inserted through the lower opening 12 of the barrel 1 and further pushed into the barrel 1 to have the retention rib 20 engaging the snapping groove 101 to secure the writing implement 2 inside the lower section of the barrel 1. The body 21 of the writing implement 2 is axially dimensioned so that when the retention rib 20 engages the snapping groove 101, the end cap 23 of the writing implement 2 exactly abuts against the inclined face 102 inside the barrel 1 in order to soundly support the writing implement 2 against reaction induced thereon due to the writing operation and maintain proper position of the writing implement 2 with the conic end 22 projecting beyond the lower opening 12 of the barrel 1. When the writing implement 2 is not to use, the user may hand grip the conic end 22 and forcibly pull the writing implement 2 out of the barrel 1, with which the retention rib 20 is forced out of the snapping groove 101 to allow easy removal of the writing implement 2. After the writing implement 2 is removed out of the barrel 1, the writing implement 2 is reversed and is fit into the barrel 1 again with the conic end 2 passes through the lower opening 2 first. Once the writing implement 2 is received into the barrel 1 again, the retention rib 20 re-engages the snapping groove 101 and a central tip of the conic end 22, which is also a writing tip of the writing implement 2, is exactly put against a central point of the inclined face 102. Preferably, the inclined face 102 is formed by a circumferential inward projection having a triangle cross section and a through hole is defined at a central point of the circumferential inward projection to allow the writing tip to extend therein.

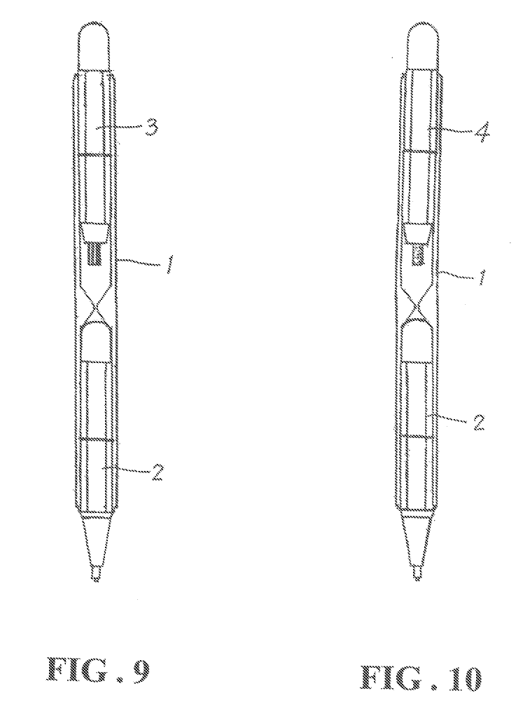

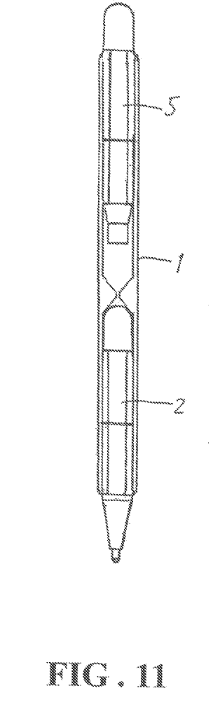

The above operation can also be applied to other devices discussed above, including the lead container 3, the eraser holder 4, and the correction liquid container 5, which can be releasably and removably fixed inside the barrel 1 by having the retention rib 30, 40, 50 engaging the snapping groove 101. Any desired combination can be done by the user, including combining two of these devices 3, 4, 5 with the barrel 1. This is illustrated in FIGS. 9-11. FIG. 9 illustrates a writing implement 2, which can be a mechanical pencil, and a lead container 3, which container plural leads, received in lower and upper sections of the barrel 1, respectively. Since both the lead container 3 and the mechanical pencil are combined together with the barrel 1, it is convenient for the user to carry and use the mechanical pencil 2. In addition, the lead container 3 can be fit in the barrel 1 at either direction and this is also true for the writing implement 2. Thus, a variety of combination of the lead container 3 and the writing implement 2 with the barrel 1 can be effected. The writing implement 2 can be combined with the eraser holder 4, as illustrated in FIG. 10, to provide a user with immediate erasing of incorrect writing. Similarly, dual direction combination can be done with both the writing implement 2 and the eraser holder 4. In case the writing implement 2 comprises a ball pen, then a combination of the writing implement 2 and the correction liquid container 5 with the barrel 1, as illustrated in FIG. 11, would be a convenient assembly that allows for immediate correction of incorrect writing by the ball pen 2.

To this point, it is understood that the barrel 1 is releasably fixing the devices 2, 3, 4, 5 by being provided with a snapping groove 101 that is engageable with a retention rib 20, 30, 40, 50 formed on the devices 2, 3, 4, 5 to effect combination of the devices with the barrel 1. In addition, the inclined face 102 helps maintaining the devices that are fit into the barrel 1 at proper positions and preventing the devices 2, 3, 4, 5 from being undesirably pushed into the barrel 1 by a reaction force induced by the application of the devices, leading to jamming of the devices inside the barrel 1. Further, all the devices can be mounted to the barrel 1 in a dual direction manner, and this makes the combination interesting and appealing. The end cap 23, 33, 43, 53 can be provided with any desired patterns, texture, and/or marks and can be exposed through the upper opening 13 around which the clip 11 is mounted so that when the barrel 1 is clipped to for example a pocket, the patterns, texture, or marks can be shown. It is apparent to those having ordinary skills that other devices can be put into combination with the barrel 1 provided that they are made the same outer configuration and/or geometry.

Although the present invention has been described with reference to the preferred embodiments thereof, it is apparent to those skilled in the art that a variety of modifications and changes may be made without departing from the scope of the present invention which is intended to be defined by the appended claims.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A combination pen, comprising a barrel, a writing implement, and a plurality of stationery devices, the barrel being tubular and having an inside surface on which at least one circumferential snapping groove is defined, an inclined face being formed at a middle of the inside surface of the barrel, each of the writing implement and the stationery devices comprising a body having opposite ends forming an end cap and a conic end respectively, a circumferential retention rib being formed on an outside surface of the body to releasably and selectively engage the snapping groove.

2. The combination pen as claimed in claim 1 further comprising a clip mounted to an end of the barrel.

3. The combination pen as claimed in claim 1, wherein the inclined face is circumferentially formed around the inside surface of the barrel and forming a central hole to allow extension of a writing tip of the writing implement.

4. The combination pen as claimed in claim 1, wherein the writing implement and the stationery devices is insertable into the barrel at either direction.

5. The combination pen as claimed in claim 1, wherein the writing implement and the stationery devices have opposite ends forming an end cap and a conic end, either of which extends out of the barrel when the writing implement or the stationery device is received in the barrel.
